(19) United States
(12) Patent Application Publication
(10) Pub. No.: US 2007/0084354 A1
(43) Pub. Date: Apr. 19, 2007

(54) Folding grill

(76) Inventor: Hsiao Ming, Yongjing Township (TW)

Correspondence Address: TROXELL LAW OFFICE PLLC, SUITE 1404, 5205 LEESBURG PIKE, FALLS CHURCH, VA, 22041, US

(21) Appl. No.: 11/431,050

(22) Filed: May 10, 2006

(30) Foreign Application Priority Data
Oct. 14, 2005 (TW) 94217826

(51) Int. Cl. A47J 37/07

(52) U.S. Cl. 99/450

(57) ABSTRACT

One type of folding grill which is composed of gridiron and wire netting, wherein gridiron is comprised by two U-shaped frames, they are mutually embedded into, it is pivoted into one entity at proper height after mutually embedded. As these two frames are open forward and backward, gridiron may become X-shaped, its features are as follows: pivot and block holes are respectively set near top of two frames, two pivot poles are fixed at one side of wire netting, which can pivot with pivot hole at top of one frame, downward hook is then fixed at two ends of another side of wire netting, which will be locked into block hole of another frame, so that such grill can be folded when not use, also save packing material and promote transportation, it also can also be fixed stably when use.

### BACKGROUND OF THE INVENTION

1) Field of the Invention

This invention relates to folding grill, which has relation with common grill. Namely, purpose of this folding grill is to save space when no use and to fix stably for practical use.

2) Description of the Prior Art

Owing to the two days holiday per week, people have more chance to take journey to outskirt. Usually, people often travel with their family or friends, as you know, where you go may not prepare food, in this case, barbecue may be the best choice. As matter of fact, it has been the habit to barbecue in festivals such mid-autumn festival. Therefore, barbecue has been the national sports of all citizens. However, what the grill manufacturer should do is to manufacture the grill with low cost material, simple structure with small cubage so as to save packing material and transporting or storing space, furthermore, such grill could be also fixed properly and safe in use.

### SUMMARY OF THE INVENTION

This invention is to improve above said grill basing on its shortcomings. Therefore, purpose of this invention is to provide one type of folding grill which is composed of gridiron and wire netting, wherein gridiron is comprised by two U-shaped frames, they are mutually embedded into. It is pivoted into one entity at proper height after mutually embedded. As these two frames are open forward and backward, gridiron may become X-shaped, pivot and block holes are respectively set near top of two frames, two pivot poles are fixed at one side of wire netting, which can pivot with the pivot hole at top of one frame, downward hook is then fixed respectively at two ends of another side of wire netting, which is locked into the block hole of another frame, so that such grill can be folded when not use, also save packing material and promote transportation, its whole structure is very stable in use.

### BRIEF DESCRIPTION OF THE DRAWINGS

FIG. 1 is the exploded appearance sketch map of this invention (open).

FIG. 1-A is the zoomed sketch map of section combination of this invention.

FIG. 2 is the embodiment sketch map of this invention.

FIG. 3 is the exploded combination appearance sketch map of this invention (folding).

FIG. 3-A is the zoomed sketch map of section combination of this invention.

FIG. 4 is the exploded embodiment appearance sketch map of this invention.

FIG. 5 is the combination sketch map of this invention (in side-glance direction).

FIG. 5-A is the zoomed sketch map of section combination of this invention.

FIG. 6 is another embodiment exploded appearance sketch map of this invention.

### DETAILED DESCRIPTION OF THE PREFERRED EMBODIMENTS

For your convenience to examine this invention, the structure characteristics and operation of this invention are hereby described in the following with drawings.

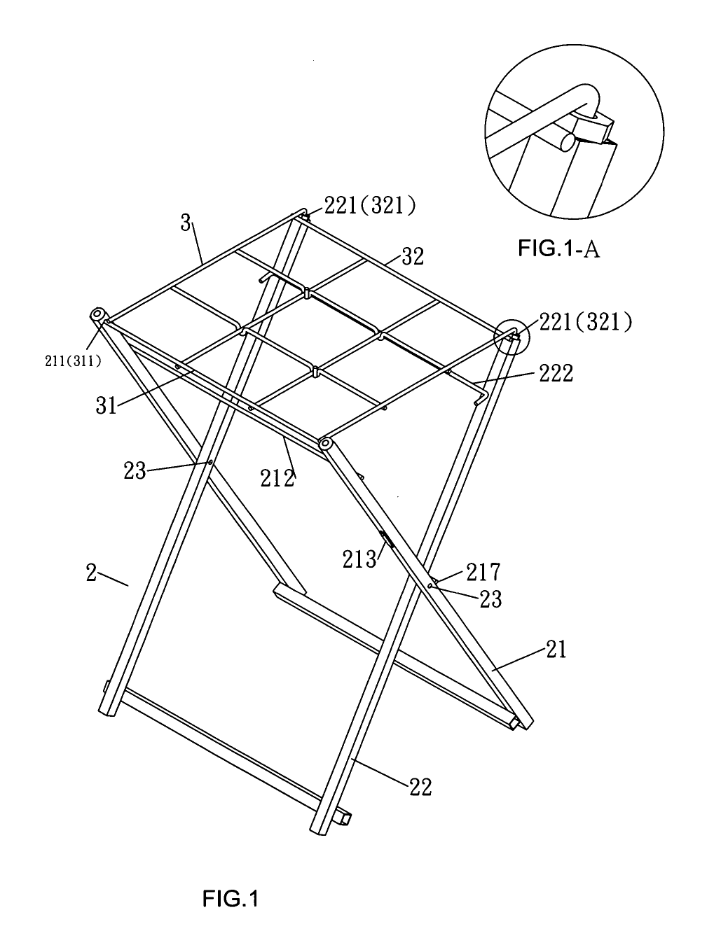

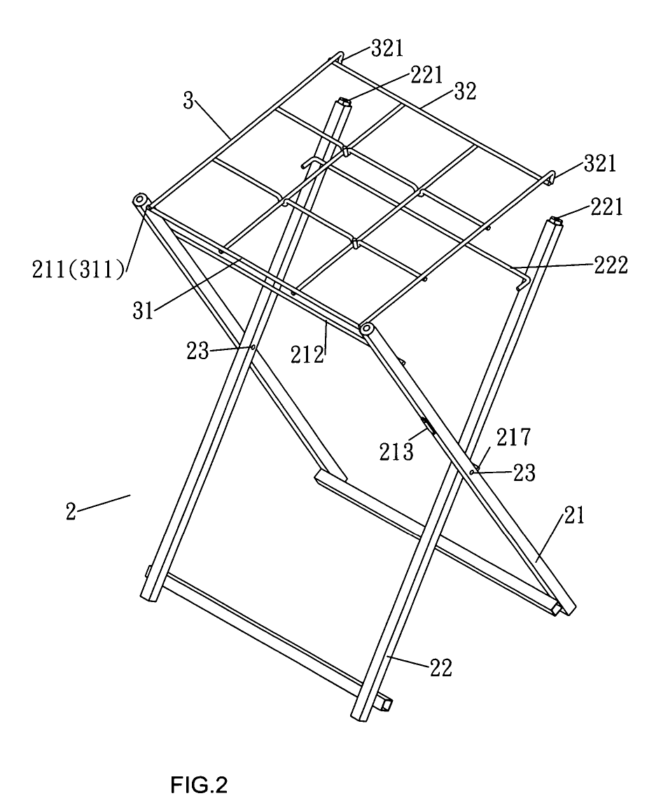

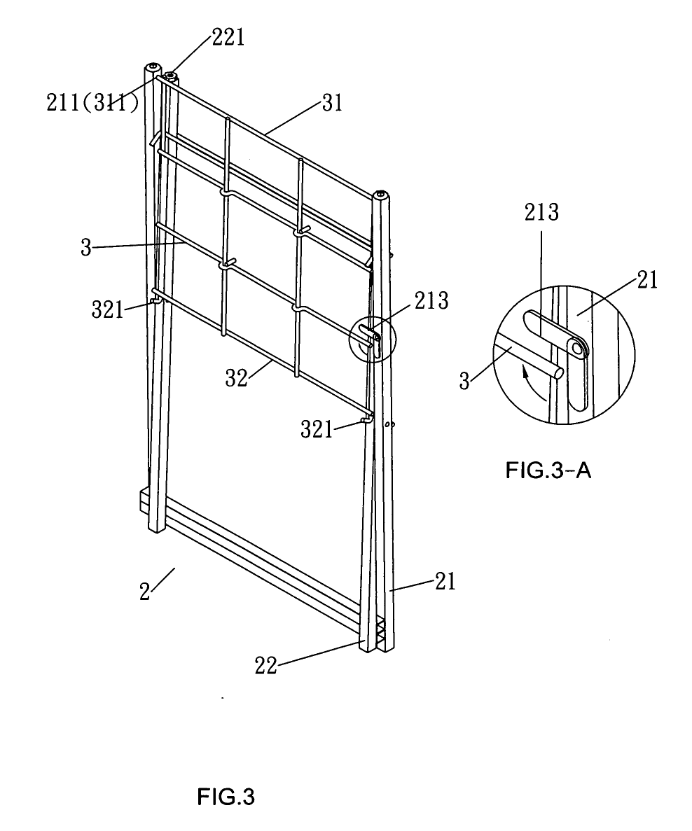

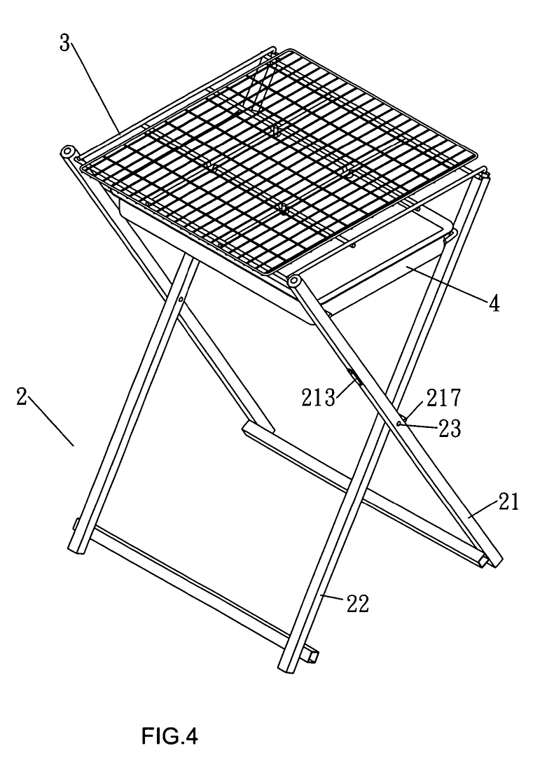

Please first refer to FIG. 1, FIG. 1-A, FIG. 2, FIG. 3, FIG. 3-A and FIG. 4, grill of this invention is composed of gridiron 2 and wire netting 3, wherein gridiron 2 is comprised by two U-shaped frames 21,22, they are mutually embedded into. It is pivoted into one entity with joint bolt 23 at proper height after mutually embedded. As these two frames 21, 22 are open forward and backward, gridiron 2 may become X-shaped with best stability. The main features of this invention are as follows: pivot hole 211 is set near top of frame 21 and block holes 221 is set at top of frame 22; meanwhile, pivot pole 311 is protruded at one side 31 of wire netting, which can pivot with the pivot hole 211 at top of one frame 21 of gridiron 2, so that wire netting 3 is pivoted with frame 21 into one entity, and whole wire netting 3 can be overturned accordingly; downward hook 321 is then fixed at two ends of another side 32 of wire netting, which is locked into block hole 221 of another frame 22 of gridiron 2 (as shown in FIG. 1-A), finally, span rods 212,222 are respectively fixed at proper position of frame 21,22 so that bottom of charcoal trough 4 can put over them (as shown in FIG. 4).

Frame 21,22 of gridiron 2 would be folded into flat shape because they can be pivoted into one entity with joint bolt 23 after embedded mutually, wire netting 3 can be pivoted into one entity with pivot pole 311 protruded at two ends of side 31 of wire netting and pivot hole 211 fixing near top of frame 21 of gridiron 2, then overturn wire netting upwards and backwards so as to let it put onto upper part of frame 21 (please refer to FIG. 2, FIG. 3 and FIG. 3-A) and buckle it with rotating location plate 213 fixing at outside of upper part of frame 21 (as shown in FIG. 3-A), so that wire netting 3 can be positioned onto its upper part, whole structure of grill can be folded accordingly.

Rotate off rotating location plate 213 to directly open gridiron 2 when use, frame 21,22 of gridiron 2 become X-shaped, then overturn wire netting 3 upwards and forward, buckle it with downward hook 321 at two ends of side 32 and block hole 221 fixing at top of another frame 22 of gridiron 2 (as shown in FIG. 1-A), finally put bottom of charcoal trough 4 over span rod 212,222 fixing under proper position of frame 21,22, so, two frames 21,22 of gridiron 2 may become X-shaped when opening, the X-shaped frame 21,22 can bear weight of meat, therefore, the grill may be fixed stably in course of barbecue.

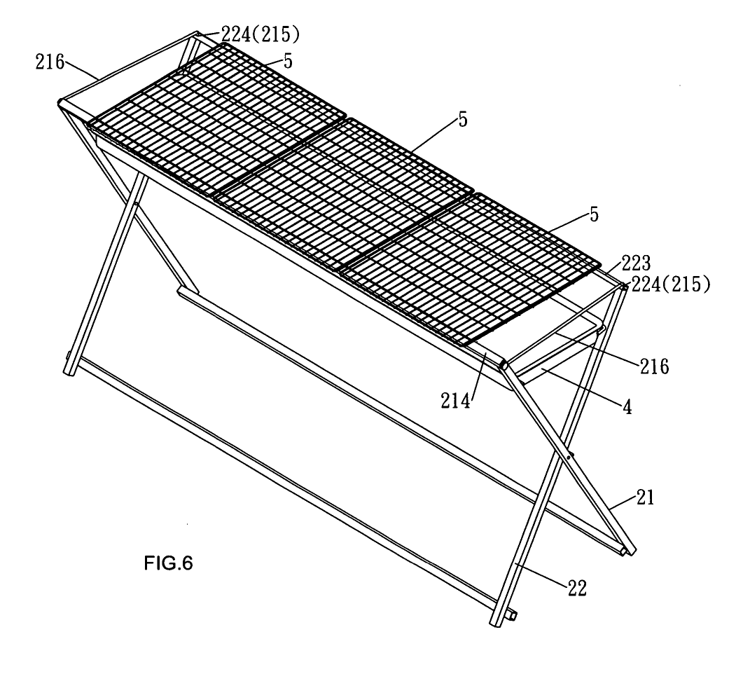

Please refer to FIG. 6, if too many people to take part in the barbecue, gridiron 2 can be extended in horizontal, span rods 214,223 are directly fixed at top of frame 21, 22, hole 224 is respectively set at two sides of top of span rod 223, two sides of span rod 214 is respectively pivoted tooling rod 216 which are positioned by downward hook 215 fixing at its end and aligning hole 224 fixing at top of span rod 223. You can open gridiron 2 to let frame 21,22 become X-shaped, buckle hook 215 fixing at end of tooling rod 216 pivoting at top sides of span rod 214 into aligning hole 224 fixing at top sides of span rod 223, and stride bottom of charcoal trough 4 over span rod 212,222 positioned horizontally below proper position of frame 21,22, finally, one or several pieces of traditional wire netting 5 can be put directly on top of span rod 214 and 223, a complete grill is assembled at this time.

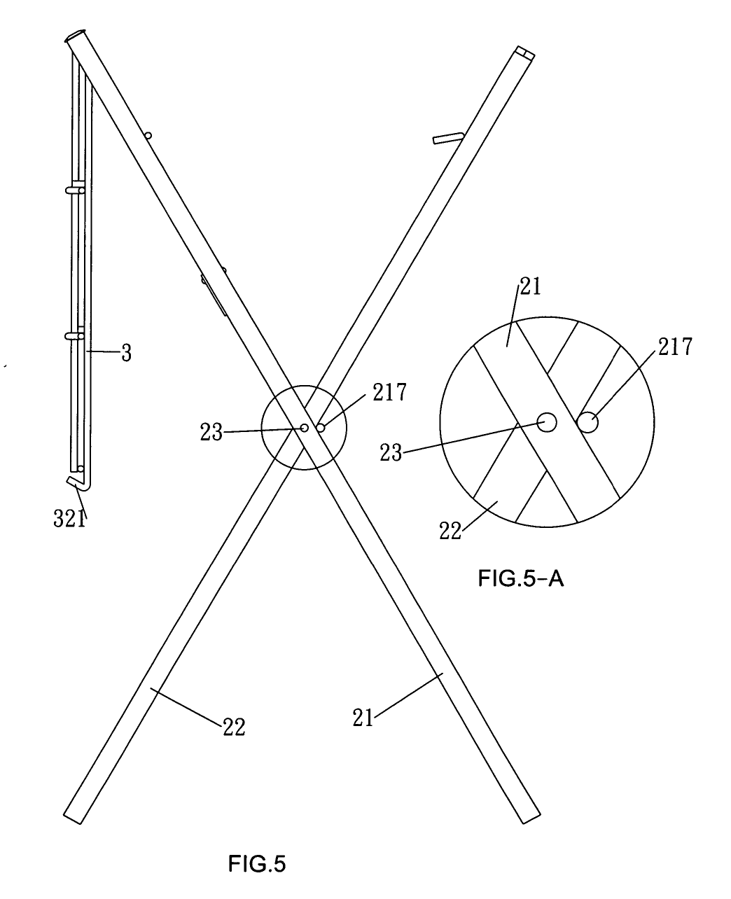

In addition, please refer to FIG. 5 and FIG. 5-A, position block 217 can be fixed at the angle between frame 21 and 22 at joint bolt 23 pivoting frame 21, 22 of gridiron 2, so, two frames may be put into exact X-shape at joint bolt 23, so that frames 21,22 will not collapse.

What is claimed is:

1. One type of folding grill, which is composed of gridiron and wire netting, wherein gridiron is comprised by two U-shaped frames, they are mutually embedded into, it is pivoted into one entity with joint bolt at proper height after embedded. Its features are as follows: pivot hole is set near top of frame and block holes is set at top of another frame; meanwhile, pivot pole is protruded at one side of wire netting, which can pivot with the pivot hole at top of one frame of gridiron, downward hook is set at two ends of its opposite side, which is buckled into block hole at top of another frame of gridiron.

2. As claimed in claim 1, it is one folding grill, wherein span rods are respectively fixed horizontally below top of two frames so that charcoal trough can put over them.

3. As claimed in claim 1, it is one folding grill, wherein gridiron can be extended in horizontal, span rods are respectively fixed at top of frame, hole is respectively set at two sides of top of one span rod, two sides of another span rod is respectively pivoted tooling rod which are positioned by downward hook fixing at its end and aligning hole fixing at top of span rod, so that one or several pieces of wire netting can be put onto them.

4. As claimed in claim 1, it is one folding grill, wherein another position block can be fixed at the angle between frames at their joint bolt.
